(19) United States
(12) Patent Application Publication
(10) Pub. No.: US 2008/0015496 A1
(43) Pub. Date: Jan. 17, 2008

(54) Safety Device for a Bottle for Medical Use

(76) Inventor: Farid Hamedi-Sangsari, Lyon (FR)

Correspondence Address: NIXON & VANDERHYE, PC, 901 NORTH GLEBE ROAD, 11TH FLOOR, ARLINGTON, VA, 22203, US

(21) Appl. No.: 11/791,823

(22) PCT Filed: Dec. 6, 2005
(86) PCT No.: PCT/FR05/51037

§ 371 Date: May 30, 2007

(30) Foreign Application Priority Data
Dec. 7, 2004 (FR) 0452894

(51) Int. Cl. A61J 1/20

(52) U.S. Cl. 604/87; 604/414; 604/82

(57) ABSTRACT

The invention relates to a device which is used to transfer a medicament from a bottle to an infusion bag or a hypodermic syringe and which comprises a tubular chamber (1). According to the invention, one end of the chamber is open (2) such that the bottle can be inserted therein, while the other end is closed by means of a divider (3) bearing a hollow needle (5). The inventive device completely covers the bottle during the use thereof. In addition, the upper part of the aforementioned chamber (1) is equipped with spring tabs (7) having a free end (8) which is directed towards the interior of the chamber. The device also comprises connection means, e.g. of the female luer lock (9) or male luer lock type.

This application is the US national phase of international application PCT/FR2005/051037 filed 6 Dec. 2005 which designated the U.S. and claims benefit of FR 0452894, dated 7 Dec. 2004, the entire content of which is thereby incorporated by reference.

### SPECIFICATION

The present invention relates to a safety device for medical use, for transferring a medication contained in a bottle to an infusion bag or a hypodermic syringe.

Existing devices for facilitating reconstitution and/or transfer operations and ensuring their safety are generally made from plastics material, whereas the bottles containing the medication are made from glass. The elimination, or recycling, of waste (a very important matter in some countries) requires the separation of glass and plastic.

Various types of transfer device are available on the market, namely:

devices which are clipped on in the factory to the stopper of the bottle only (developed by Beckton-Dickinson and Biodome): these devices are reliable in use, but the plastics part cannot be separated from the glass part

devices which are clipped on by a nurse at the time of use, to the stopper of the bottle only (developed by Senaux): these devices allow the glass bottle to be separated from the plastics device, but they have low reliability in use, since they entail risks of leakage when the nurse shakes the bottle connected to the bag to dissolve the powder (the guiding and retention of the bottle being inadequate)

devices covering the whole bottle, which are clipped on to the stopper of the bottle by the nurse at the time of use (developed by MAP): these devices are reliable in use, because the bottle is guided over its whole length, but the bottle cannot be withdrawn from the device, since the whole of the bottle is inserted into the device and therefore cannot be gripped by the user's fingers for removal.

The object of the present invention is therefore to provide a device allowing both a safe transfer and the separation of the glass from the plastics material.

Various patents describe devices for transferring a medication contained in a bottle to a bag or a syringe.

Patent FR 2 790 749 describes a device comprising two guides, the first guide comprising means for preventing the complete withdrawal of the bottle after its insertion, these means being, for example, composed of resilient lugs fixed to the inner face and pointing inwards. These lugs are elements attached to the cylinder and their function is to prevent the withdrawal of the bottle before the closure of the bottle is pierced. Additionally, the length of the guide is such that it cannot completely cover the bottle.

Patent EP 195 018 describes a device comprising two guide elements, the first element having locking means designed for a mechanical locking engagement when the device is in the position for use, and the second element comprising a sliding lock ring. The locking means of the first element are formed by a projection extending inwards from an inner surface of part of a wall, a cutout being provided in the part of the wall and extending from the base of the first guide element to the projection. The projections are positioned below the cutout. The first guide element covers only the neck of the bottle.

Patent FR 2 473 017 describes a sleeve formed by a hollow cylindrical body having a circular separating partition. The entrance to one of the sections has an inner lip which narrows the entrance aperture to retain the bottle in a sealed way in the axis of the sleeve before the bottle closure is pierced. The length of the sleeve is such that it cannot completely cover the bottle.

Patent FR 2 613 220 describes a needle holder formed by two sleevelike parts joined by a closed end wall, the part intended to house the neck of the bottle having radial cams or a circumferential rib for fixing the container. The length of the sleeve is such that it cannot completely cover the bottle.

Patent FR 2 780 878 describes a transfer cap for passing a medication between a bottle and a solution bag, comprising a one-piece tubular body and a needle, characterized by clip-on means in the form of a resiliently flexible longitudinal tab provided with an inwardly directed boss.

None of these devices permits both a safe transfer and the separation of the glass from the plastics material.

The present invention is an improvement of the device described in patent FR 2 828 803 in the name of the present applicant.

Patent FR 2 828 803 describes an economical packaging device for a bottle for medical use, composed of a one-piece cylindrical body of plastics material formed by two parts which are separated by a partition perpendicular to the axis of the tubular body, namely a lower part for completely covering the glass bottle and an upper part of smaller diameter formed by a cylindrical chamber containing means, such as a double-pointed needle, for transferring the contents of the bottle into a container such as an infusion bag.

This device simultaneously meets the requirements of safety of personnel and protection from breakage, but since the bottle cannot be gripped for removal, the glass bottle cannot be separated from the plastic device for selective sorting.

The present invention proposes to overcome this problem by providing an improvement to this device which completely covers the bottle.

The device according to the present invention is composed of a tubular chamber whose open end allows the insertion of the bottle and whose other end is closed by a partition carrying a hollow needle; the device completely covers the bottle during its use, and is provided in the upper part of the chamber with resilient tabs whose free ends project towards the inside of the chamber; the base of each tab forms an integral part of the chamber, and each tab lies inside an aperture which surrounds the other three sides of the tab and opens on to the partition at a radial depth at least equal to the penetration of the free end of the tab into the chamber.

The attached drawings enable the present invention to be illustrated in greater detail.

FIG. 1 is a front view of the device according to the present invention with a female Luer lock.

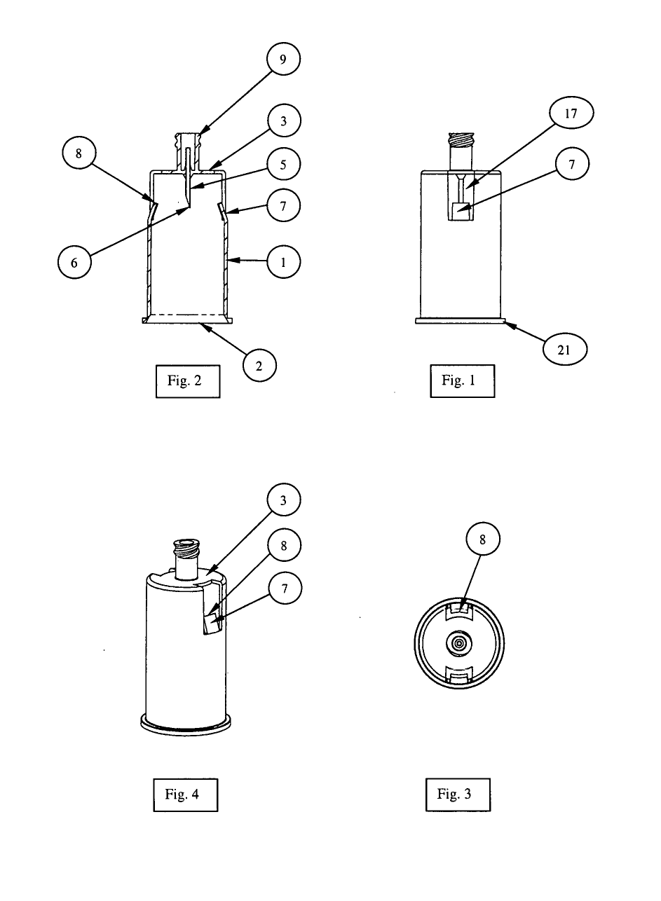

FIG. 2 is a sectional view of the device of FIG. 1.

FIG. 3 is a view from above of the device of FIG. 1.

FIG. 4 is a perspective view of the device of FIG. 1.

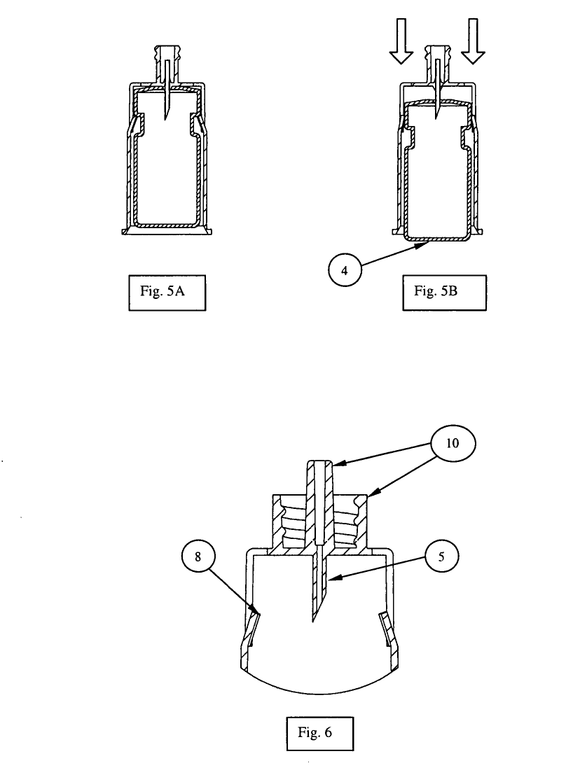

FIGS. 5A and 5B show a sectional view of the device according to the present invention associated with a bottle when the bottle is inserted (FIG. 5A) or during the removal of the bottle (FIG. 5B).

FIG. 6 is a sectional view of the upper part of the device according to the present invention with a male Luer lock.

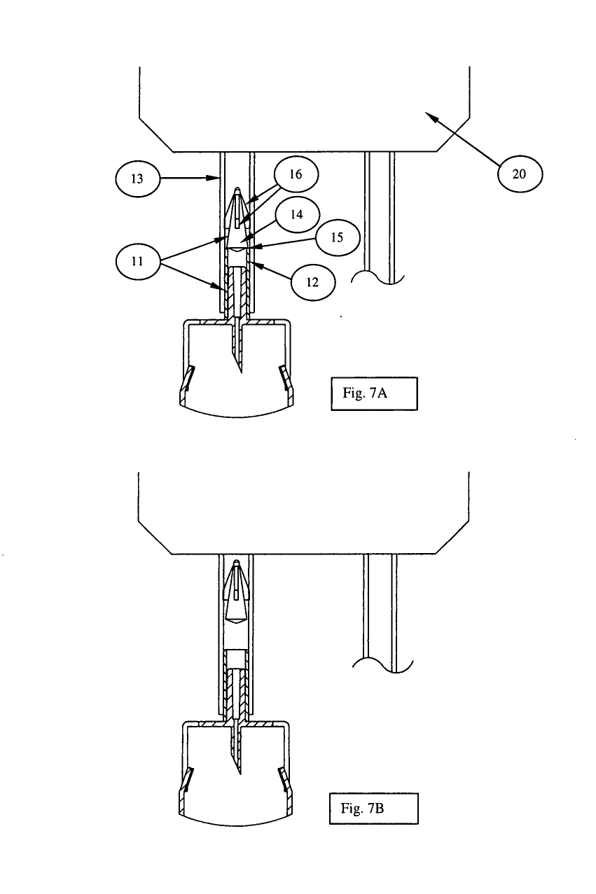

FIGS. 7A and 7B show a sectional view of the upper part of the device according to the present invention with a plug having a breakable area in the storage position (plug unbroken, FIG. 7A) or in the position for use (plug broken, FIG. 7B).

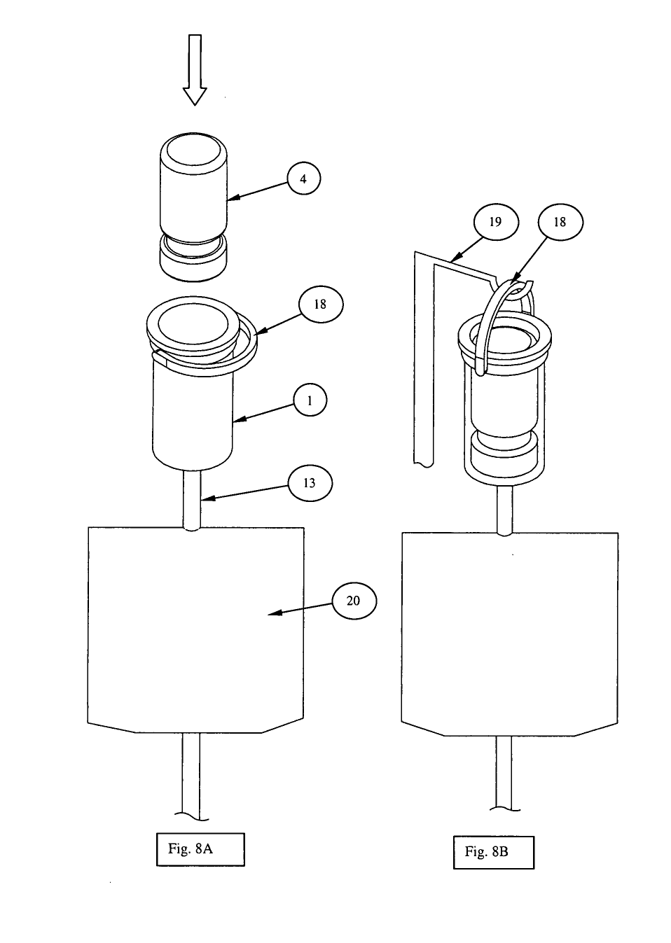

FIGS. 8A and 8B show the device according to the present invention connected to an infusion bag by a flexible tube containing a plug with a breakable area and equipped with suspension means, with the suspension means folded away to permit the insertion of the bottle (FIG. 8A) and with the assembly of device, bottle and bag in the suspended position after the suspension means have been brought into action (FIG. 8B).

FIGS. 1-4 show a device according to the present invention, composed of a tubular body (1), preferably cylindrical, with an open end (2) for the insertion of the bottle (4), the other end being closed by a partition (3) perpendicular to the axis of the chamber (1), one of the functions of this partition being to act as a stop for the bottle (4). This partition (3) has a hollow needle (5) passing through its centre, the point (6) of the needle pointing towards the open end of the chamber and the length of the needle being sufficient to pierce the pierceable stopper of the bottle (4). This needle (5) can be made from plastics moulded in one piece with the partition (3) and the chamber (1) of the device, or from stainless steel, in which case it is fixed to the partition by bonding or overmoulding.

The present invention is characterized by apertures (17) formed in the upper part of the tubular chamber (1) and opening on to the partition (3). The chamber (1) has one or more apertures (17) distributed over its periphery. Each aperture (17) has a resilient tab (7) whose free end (8) is directed towards the inside of the chamber (1). The distance between the free end (8) of each tab (7) and the partition (3) is slightly greater than the total thickness of the stopper of the bottle (4). The base of the tab (7) forms an integral part of the chamber (1), the aperture (17) surrounding the other three sides of the tab (7). The width of the aperture (17) is greater than the width of the tab (7). The apertures (17) open on to the partition (3) with a radial depth greater than the penetration of the tabs (7) into the tubular chamber (1). This detail of the embodiment is important, since it enables the device to be produced with a mould which requires no “slider blocks” for removal from the mould (thus making the mould less costly and less fragile).

The shape of the free ends (8) of the resilient tabs (7) is to be designed, for convenience of use, in such a way that the bottle can be inserted with a relatively small force and can be removed with a markedly greater force, to avoid any risk of undesirable detachment of the bottle while it is being shaken (for example, using a removal force of 3 daN for a maximum bottle weight of 50 g).

The side of the partition (3) opposite the chamber (1) has means for connecting the bottle (4), after its insertion into the chamber (1), to an infusion bag (20) or to a hypodermic syringe. In the embodiment shown in FIGS. 1 to 4, these means are of the female Luer lock type (9).

In a preferred embodiment, the tubular chamber (1) has means on its base for increasing the stability of the device in the vertical position, for facilitating the distribution of the piece in an automated industrial process, and for providing a larger surface area to withstand the force of removal from the mould. These means may take the form of a collar (21), for example.

FIGS. 5A and 5B show the device according to the present invention associated with a bottle (4). In FIG. 5A, the assembly is shown with the bottle inserted. The partition (3) acts as a stop for the stopper of the bottle (4) which is pierced by the needle (5); the bottle is held in position by the tabs (7), and the tubular chamber (1) completely covers the body of the bottle (4). FIG. 5B shows the removal of the bottle. When pressure is applied to the stopper of the bottle, the resilient tabs are pinned to the wall of the chamber, enabling the bottle to be released from the device. The apertures (17) are designed to allow the user's fingers to press on the stopper of the bottle, so as to expel it from the tubular chamber (1); the bottle can thus be recovered and then destroyed or recycled independently of the device.

FIG. 6 is a sectional view of the upper part of a device according to the present invention. In this embodiment, the tubular chamber (1) is identical to that shown in FIGS. 1 to 4, but the means for connecting the bottle (4), after its insertion into the chamber (1), to an infusion bag (20) or to a hypodermic syringe are in the form of a male Luer lock.

FIGS. 7A and 7B show a sectional view of the upper part of a device according to the present invention associated with an infusion bag (20). In this embodiment, the tubular chamber (1) is identical to that shown in FIGS. 1 to 4, but the means for connecting the bottle (4), after its insertion into the chamber (1), to the infusion bag (20) are in the form of a plug with a breakable area (11).

FIG. 7A shows the device according to the present invention, with the plug with the breakable area (11) in the storage position (plug unbroken). The plug with the breakable area (11) is formed by a cylindrical tubular part (12) whose outside diameter is slightly greater than the inside diameter of the flexible tube (13) for access to the bag, thus ensuring that the assembly is sealed by a tight fit. One of the ends of this tubular part (12) is open and the other is closed by a breakable portion, preferably of conical shape (14). The largest diameter of this conical part (14) is less than the inside diameter of the flexible tube (13), and the conical part (14) is fixed to the tubular part (12) by means of a weakened area (15) which can be broken by the exertion of a radial forward and backward force on the flexible tube (13). The conical part (14) has at least two fins (16) distributed around its periphery. These fins are preferably triangular, so as to facilitate the insertion of the plug with the breakable area (11) into the tube (13). The bases of the triangular fins (16) lie inside a circle whose diameter is slightly greater than the inside diameter of the tube (13), and they terminate in sharp corners, so as to oppose the withdrawal of the breakable part (14) from the tube (13).

FIG. 7B shows the device according to the present invention, with the plug with the breakable area (11) in the position for use (plug broken). When the nurse breaks the weakened area (15) of the plug with the breakable area (11) by a forward and backward bending movement of the tube (13), the breakable part (14) moves one to two millimetres farther into the tube (13), and then remains in this position because of the friction of the fins (16) on the tube (13) and because of the sharp corners of the bases of the fins (16) which act as anti-return means. This embodiment ensures that the breakable area (14) separated from the tubular part (12) cannot return to block this tubular part under the effect of gravity or the flow of liquid. After the breaking of weakened area (15) of the plug with the breakable area (11), the liquid can flow through the passage between the fins, owing to the space of 1-2 millimetres created by the detachment of the breakable part (14) from the tubular part (12).

FIGS. 8A and 8B show the device according to the present invention connected to an infusion bag (20) by a flexible tube (13) for access to the bag, containing a plug with a breakable area (11) and provided with suspension means (18). In FIG. 8A, the suspension means are shown in the folded away position where they permit the insertion of the bottle (4). This improvement is particularly useful when the connection of the device containing the bottle (4) to the infusion bag (20) is made in the upper part of the bag.

In FIG. 8B, the device/bottle/bag assembly is in the suspended position after the suspension means have been brought into action. These suspension means are composed, for example, of a handle (18) which can be attached to an infusion stand (19).

The figures show an embodiment in which the contents of a bottle (4) are put into communication with an infusion bag (20). However, the system can be used to put the contents of a bottle in communication with another type of container, such as a hypodermic syringe.

In a specific embodiment, the device is packaged in a sterile blister pack. This is particularly applicable to the “female Luer lock” and “male Luer lock” models.

When these models are used, the nurse removes the device from its blister pack and then inserts the bottle (4) into the tubular chamber (1). When the needle (5) has pierced the stopper of the bottle (see FIG. 5A), the nurse connects the device comprising the bottle to an infusion bag or to a syringe.

In the case of connection to a bag, the nurse holds the device/bottle/bag assembly vertically, with the device downwards, and presses the bag (20) several times: the liquid contained in the bag (20) flows into the bottle (4) until it has about half filled it. The nurse shakes the assembly until the powder contained in the bottle is fully dissolved, then turns the assembly over with the bag downwards, and presses the bag several times to ensure that the contents of the bottle are fully transferred into the bag. The infusion is then ready for injection into the patient.

In the case of connection to a syringe, in other words when the medication has to be administered in a measured dose or injected intravenously, intramuscularly or subcutaneously, the nurse connects the device/bottle assembly to a syringe containing the precise dose of solvent for diluting the medication contained in the bottle (4). The nurse injects all the contents of the syringe into the bottle (4), and then shakes the assembly until the powder contained in the bottle (4) is completely dissolved. The nurse then draws off the prescribed dosage of medication, using the graduation on the syringe. The contents of the syringe are then either transferred to a bag or injected directly into the patient. The remaining medication in the bottle will be destroyed.

In another specific embodiment, the device is fitted to the bag (20) in the factory, in the conventional position for injection (see FIGS. 8A and 8B), and it cannot be separated from the bag (20). When the plug with the breakable area (11) is intact, it acts as a sealed plug. The bag/device assembly is then packaged in a sealed way and subsequently sterilized.

When it is used, the nurse proceeds as for the devices with Luer connections, but the operations of unpacking the device and connecting it to the bag (20) are eliminated. To make the liquid flow into the bottle (4), it is simply necessary to break the weakened area (15) of the plug with the breakable area (11), as described previously.

These factory-fitted devices have a number of advantages, namely:

a saving made by eliminating the blister pack for the device and its sterilization

a saving of time for the nurse (the device does not have to be unpacked and connected to the bag)

enhanced patient safety, because the risk of accidental contamination is proportional to the number of connections and disconnections.

By using devices according to the present invention, it is possible to achieve the safe transfer of a medication contained in a glass bottle to a bag or hypodermic syringe, together with the elimination or recycling of waste due to the separation of the glass from the plastics material.

The sorting of the waste (containing different materials and residues of medication, according to their hazard rating) will be carried out either by the specialist hospital service, or by an authorized external organization.

The description and the figures illustrate different embodiments of the present invention. However, the invention is not limited to the embodiments described and illustrated, but includes all variants.

1- Device for transferring a medication contained in a bottle (4) into an infusion bag (20) or a hypodermic syringe, composed of a tubular chamber (1) whose open end (2) allows the insertion of the bottle (4) and whose other end is closed by a partition (3) carrying a hollow needle (5), the device completely covering the bottle during its use and being provided in the upper part of the chamber (1) with resilient tabs (7) whose free ends (8) are directed towards the inside of the chamber, characterized in that the base of each tab (7) forms an integral part of the chamber (1) and each tab (7) lies inside an aperture (17) which surrounds the other three sides of the tab (7) and opens on to the partition (3) at a radial depth at least equal to the penetration of the free end (8) of the tab (7) into the chamber (1).

2- Device according to claim 1, characterized in that the free ends (8) of the tabs (7) bear on the rounded profile of the crimped part of the stopper of the bottle (4).

3- Device according to claim 1, characterized in that it has female Luer lock (9) or male Luer lock (10) means for connecting the said device to a bag or a syringe.

4- Device according to claim 1, characterized in that it has means for connecting the said device to a bag (20), composed of a plug with a breakable area (11) formed by a cylindrical tubular part (12) which can be force-fitted to the flexible tube (13) for access to the bag (20), the said tubular part (12) being closed on the bag side by a breakable portion (14), preferably of conical shape, provided with at least two fins (16), preferably of triangular shape.

5- Device according to claim 1, characterized in that it has means (18) for suspension from an infusion stand (19), these means being located in the proximity of the open end (2) of the chamber (1).

6- Device according to claim 5, characterized in that the suspension means (18) can be folded away to permit the insertion of the bottle (4) into the chamber (1).

7- Device according to claim 1, characterized in that the needle (5) for piercing the stopper of the bottle is made from plastics material injection moulded in one piece with the whole device.

8- Device according to claim 1, characterized in that the needle (5) for piercing the stopper of the bottle is made from stainless steel and is fixed to the device by bonding, welding or overmoulding.

9- Device according to claim 1, characterized in that it is packaged in a blister pack and then sterilized.

10- Device according to claim 1, characterized in that the chamber (1) has a collar (21) at its base.
